(19) United States
(12) Patent Application Publication
(10) Pub. No.: US 2008/0195475 A1
(43) Pub. Date: Aug. 14, 2008

(54) Advertiser portal interface

(76) Inventors: Matthew Cody Lambert, Knoxville, TN (US); Kevin Travis Woods, Knoxville, TN (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/703,962

(22) Filed: Feb. 8, 2007

(51) Int. Cl. G06Q 30/00

(52) U.S. Cl. 705/14

(57) ABSTRACT

To help customers make purchasing decisions, metrics can be measured and displayed to a user. In one embodiment, the metrics displayed include at least a portion of a measured metric over a first period of time, at least a portion of a current metric, and at least a portion of a projected future metric over a second period of time. In one embodiment, a system receives information relating to a target audience or advertisement delivery preferences of an advertiser. The system can display to the user an interface comprising a chart showing at least some historical impressions over a first period of time, at least some current impressions, and at least some projected future proposed impressions over a second period of time. In one embodiment, the user can use the interface to purchase and/or to bid for advertisement placements.

### BACKGROUND

1. Field

The present disclosure relates to advertising technology and, more particularly, to an interface that displays metrics to assist an advertiser in making a media advertising purchasing decision.

2. Description of Related Art

Purchasing decisions may be made in a variety of ways. A purchasing decision may be made on the basis of performance data acquired by the purchaser from others, data relating to purchases made by the purchaser's competitor, data gleaned from the purchaser's past experiences, or a purchaser's perception of quality or value, for example. An advertiser may make a purchasing decision using a table filled with data relating to profit information, ad performance, time period impression counts, time period user action counts, ad group IDs, ad campaign IDs, account IDs, ad metric targets, and ad metric limits, for example. The records of data that form the basis of an advertiser's purchasing decision may become voluminous and unwieldy.

Advertisers can reach audiences via a multitude of delivery channels and in many formats. Current communications technologies allow advertisements to be delivered through many channels, including conventional signage, postal services, terrestrial broadcast radio and television, satellite audio and video transmission, cable television and telephone networks, cellular and other wide area wireless data networks, and the Internet. Available advertisement formats include billboards, postal mail, e-mailings, audio messages, video commercials, Web site-based banner advertisements, sponsored hypertext links, text messages, multimedia files passed over data networks or the Internet, and streaming media advertisements. Advertisers may use a combination of advertising delivery channels and formats to achieve their goals.

Advertisers may seek to deliver an advertisement to an audience that meets certain demographic and/or geographic criteria. For example, advertisers may be willing to pay a premium to those able to display their video advertisements to target viewers that are more likely to purchase the advertiser's products or services. Alternatively, an advertiser may wish to simply maximize the number of people exposed to its message.

The ability to target advertisements, such as video advertisements, audio advertisements, banner advertisements, static advertisements, combinations thereof, or the like, may be valuable to advertisers. Targeting may occur, for example, by characterizing the segment of the population that is the most likely consumer of the product or service. Markets may be segmented by a myriad of characteristics such as gender, age, income, occupation, education level, special hobbies, geography, demographics, and so forth. By communicating the advertisement using those media that are more likely to be seen by the target market segment or target viewer, advertising is made more efficient.

An advertiser may want to deliver a precise number of impressions of the targeted advertisement, without over-delivering or under-delivering the advertisement. For instance, an advertiser may wish 5,000,000 people between the ages of 16 and 25 to watch that advertiser's advertisement at a specific time. Therefore, the advertiser wishes for 5,000,000 “impressions” of the advertisement to be displayed to the targeted market segment.

In order to facilitate the needs of advertisers and to maximize advertising revenue, content providers may seek to avoid underutilization of available inventory. Content providers may have an expected number of advertising impression opportunities that can be reserved for advertisements, and they may wish to maximize the proportion of available impression inventory that is sold. A content provider may also attempt to avoid over-committing or over-subscribing the available inventory.

In a commercial-supported television environment, a broadcaster may have a defined number of times for a specific period between breaks of broadcast programming. The broadcaster can only sell one time to one advertiser. Consequently, the advertiser can specify a number of timeslots that the advertiser's advertisement is to be displayed. Viewership within these timeslots is measured by standard ratings data, which is then used to estimate a specific impression count. Broadcasters use these estimates to determine whether they over or undersold their advertisement inventory. Advertisers use this information to ensure that the number of impressions desired was met or exceeded.

The same goals of advertisers and broadcasters may arise for delivering advertisements via the Internet or other channels. Various other systems and methods have been developed to enable the advertiser and broadcasters to meet their goals. For example, some systems utilize a centralized ad-server that delivers advertisement upon request from an application or Web page at the moment that an ad is needed, makes a real-time decision of which ad to deliver, and tracks the delivery of advertising impressions. This decision may be based upon the number of impressions requested by the advertiser, the number of impressions already delivered, the time remaining for the advertising campaign, and the targeting criteria of the advertisement, for example.

New technology is permitting broadcasters to move away from the traditional limitations of delivering only a single advertisement to all households within a single timeslot. For example, new targeted advertising technologies allow broadcasters to deliver different advertisements to different households within a single timeslot, based on interest, location or demographics. Further, new advertising opportunities arise when viewers use a broadcaster's program guide or access content over the Internet, which may be accessed on demand rather than during defined timeslots.

### SUMMARY

An embodiment of the present disclosure provides a method of displaying advertising metrics to an advertiser in order to assist in media advertising purchasing decisions, which may comprise: receiving from the user information relating to at least one of a target audience of the advertiser or advertisement delivery preferences of the advertiser; defining a selection of one or more proposed media advertising placements based on the information received from the user; calculating projected future proposed impressions that will result from the selection of one or more proposed media advertising placements; obtaining a measurement of current impressions that result from at least some media advertising placements ordered by the advertiser; maintaining at least some measured historical impressions that result from at least some media advertising placements ordered by the advertiser; and providing to the user an interface comprising a representation, such as, for example, a chart, of a number of impressions as a function of time; and showing at least some of the historical impressions over a first period of time, at least some of the current impressions, and at least some of the projected future proposed impressions over a second period of time.

The foregoing method may also comprise obtaining information about one or more media advertising placements secured by the advertiser, calculating projected future secured impressions that will result from the one or more secured media advertising placements, and displaying on the chart at least a portion of the projected future secured impressions.

The foregoing method may comprise receiving from the user one or more purchasing preferences of the advertiser; receiving a purchasing instruction from the user to purchase at least a portion of the selection of one or more proposed media advertising placements; and fulfilling the purchase by using at least some of the purchasing preferences.

Still in the foregoing method, it may comprise: recording properties of media advertising placements associated with at least some of the measured historical impressions in a historical advertising order repository; receiving from the user a request to create a selected time interval within the portion of the chart corresponding to the first period of time; displaying on the chart one or more elements to delineate the selected time interval; and displaying in the interface at least some of the properties of the media advertising placements associated with the historical impressions that occurred within the selected time interval.

Further in the foregoing method, it may comprise: receiving from the user a request to create a selected time interval within the portion of the chart corresponding to the second period of time; and displaying on the chart one or more elements to delineate the selected time interval.

The foregoing method may further comprise: determining a total inventory of impressions available for future orders; and displaying on the chart the total inventory of impressions available for future orders.

Another embodiment of the present disclosure provides a system for displaying advertising metrics to an advertiser in order to assist in media advertising purchasing decisions comprising a computer-readable memory device comprising instructions for: receiving from the user information relating to at least one of a target audience of the advertiser or advertisement delivery preferences of the advertiser; defining a selection of one or more proposed media advertising placements based on the information received from the user; calculating projected future proposed impressions that will result from the selection of one or more proposed media advertising placements; obtaining a measurement of current impressions that result from at least some media advertising placements ordered by the advertiser; maintaining at least some measured historical impressions that result from at least some media advertising placements ordered by the advertiser; and providing to the user an interface comprising a representation of a number of impressions as a function of time, and showing at least some of the historical impressions over a first period of time, at least some of the current impressions, and at least some of the projected future proposed impressions over a second period of time.

In the foregoing system, the interface may comprise a second chart having a time axis, having an axis that represents a number of impressions, and showing at least some of the historical impressions over a third period of time longer than the first period of time. The first and second periods of time may be not longer than about seven days, and the third period of time may be not shorter than about six months. The duration of the first and second periods of time may also be stored individually as user preferences.

Still in the foregoing system, the interface may comprise a time axis domain modification element that changes a duration and/or a starting time of the first and/or second periods of time without changing the magnitude of a sum of the first and second periods of time. The interface may also comprise a time axis scale modification element that changes the magnitude of a sum of the first and second periods of time.

Further in the foregoing system, the chart representing a number of impressions as a function of time may comprise a chart representing a number of impressions as a function of at least about a fifteen-minute interval of time.

The computer-readable memory device in the foregoing system may comprise instructions for: obtaining a reading of a secured portion of a total inventory of impressions that is at least one of already secured by the advertiser or unavailable to the advertiser; and displaying on the chart at least a portion of the secured portion of the total inventory of impressions.

In the foregoing system, the first chart may comprise at least one of a first line or a first area representing a portion of total inventory that is already secured by the advertiser and at least one of a second line or a second area representing a portion of total inventory that is otherwise unavailable to the advertiser, and wherein the at least one of a first line or a first area is a different color than the at least one of a second line or a second area.

In the foregoing system, the interface may comprise an element that allows the user to at least one of immediately bid on or immediately purchase at least a portion of the selection of one or more proposed media advertising placements by operating the element.

One embodiment provides a system for providing information to assist in a media advertising purchasing decision comprising: a processor that projects a magnitude of future impressions as a function of time; a data module that obtains measurements of current impressions; a storage medium that maintains at least some measured historical impressions; and an interface that provides user prompts in order to obtain purchasing preferences from a user, provides one or more interface elements that allow the user to provide criteria to filter an inventory of advertising impressions, and provides a representation of at least some of the historical impressions over a first period of time, at least some of the current impressions, and at least some of the projected future impressions over a second period of time.

In the foregoing system, the data module can comprise program code for obtaining measurements of current impressions from an impressions data source. The storage medium can maintain an inventory of available media advertising placements. The storage medium can also maintain at least one of customer purchasing preferences or customer billing information. The storage medium may comprise one or more hard disk drives.

Still in the foregoing system, the system may include a query module that selects one or more proposed media advertising placements based on information received from the user. The system can also include a communications network over which the interface receives instructions from the user and provides information to the user. The system can include a communications network over which the data module communicates with a source of advertising metrics measurements.

An embodiment of the present disclosure provides a system for displaying metrics to a user in order to assist the user in a purchasing decision comprising: means for receiving from the user a criterion to filter an inventory of a product; means for defining a selection of one or more proposed orders for the product based on the criterion; means for calculating a projected future metric that will result from the selection of one or more proposed orders; means for obtaining a measurement of a current metric that results from at least some orders placed by the user; means for retaining a measured metric that resulted from at least some orders placed by the user; and means for displaying to the user at least a portion of the measured metric over a first period of time, at least a portion of the current metric, and at least a portion of the projected future metric over a second period of time.

These and other embodiments are described in greater detail below.

### BRIEF DESCRIPTION OF THE DRAWINGS

FIG. 1 is a diagram of an example system for displaying information to a user to assist the user in a purchasing decision.

FIG. 2 is a diagram of an example structure for a media advertising order data object.

FIG. 3 is a diagram of an example system that assists an advertiser in a media advertising purchasing decision.

FIG. 4 shows an embodiment of an interface that presents metrics to an advertiser.

FIG. 5 shows an embodiment of an interface element including a zoomed-out view of advertising impressions over time.

FIG. 6 is a flowchart exemplifying the operation of a system that presents metrics to an advertiser.

FIG. 7 shows an embodiment of a method for maintaining a record of historical impressions.

FIG. 8 shows an embodiment of an interface that displays attributes of historical advertising orders.

FIG. 9 is a flowchart exemplifying the operation of a system that displays attributes of historical advertising orders.

FIG. 10 shows an embodiment of an interface that displays information pertaining to future advertising orders.

FIG. 11 is a flowchart exemplifying the operation of a system that displays information pertaining to proposed advertising orders and fulfills media advertising purchase instructions.

### DETAILED DESCRIPTION

Hereinafter, various example embodiments of the present disclosure will be described in detail with reference to the attached drawings such that the present disclosure can be put into practice by those skilled in the art. However, the present disclosure is not limited to the example embodiments, but may be embodied in various forms. For example, while some embodiments that will be described are directed to systems and methods for assisting in advertising purchasing decisions, at least some of the techniques described herein are also applicable to other types of decision making. Some embodiments allow simultaneous review of the performance of historical orders, even when there is no interest in making new purchases. As another example, while some embodiments are described herein using example data structures or an example order of steps, embodiments using alternative data structures or alternative steps and orders of steps are appropriately within the scope of the present disclosure, as will be appreciated by a person of ordinary skill in the art in view of the present disclosure.

Tracking historical impressions and securing a requested number of future targeted impressions can become difficult for an advertiser when, for example, multiple delivery channels and/or advertisement formats are used. There may be lack of commercially-available ratings data to determine the number of households matching a particular interest, location or demographic target viewing during a specific timeslot, making total impression inventory difficult to measure and historical impression results difficult to compile. Meanwhile, complex text-based reports of advertising order performance from multiple delivery channels in multiple formats make media advertising purchasing decisions more time-consuming and difficult.

Embodiments of the present disclosure include systems and methods for displaying metrics to an advertiser in order to assist in a media advertising purchasing decision. Some embodiments also allow simultaneous review of the performance of historical orders. In some embodiments, at least some of the metrics are displayed in an interface presented to the user. In a preferred embodiment, the interface comprises a chart representing a number of advertising impressions, which are also known simply as impressions, as a function of time. An “impression” is a delivered basic advertising unit from an ad distribution point. For example, if the ad distribution point is a roadside billboard, an impression may occur when a driver of a car passes the billboard. As another example, if the ad distribution point is a banner advertisement on a Web page, an impression may occur when a visitor views the Web page.

In some embodiments, an interface, or a chart within the interface, shows at least some historical impressions over a first period of time, at least some current impressions, and at least some projected future impressions over a second period of time. “Historical impressions” refer to a count of impressions that resulted from one or more previous or current advertising orders. “Current impressions” refer to a count of impressions that have resulted from one or more current advertising orders over a relatively short period of time near the point in time when the advertiser is viewing the interface. “Projected future impressions” refer to a projection of a count of impressions that will result from one or more previous, current, or future advertising orders.

In some embodiments, an interface, or a chart within the interface, shows at least a portion of projected future secured impressions. “Projected future secured impressions” refer to a projection of a count of impressions that will result from previous or current advertising orders that have already been secured by an advertiser. Projected future secured impressions may be limited to impressions that have been secured by a particular advertiser. Projected future secured impressions may also include impressions that have been secured by other advertisers or impressions in an advertising inventory that are otherwise unavailable. The terms “inventory,” “advertising inventory,” and “impressions inventory” refer to the total number of impressions or available impressions for one or more target audiences and/or advertisement delivery options. “Total inventory” may include the total number of impressions available for all target audiences and/or all advertisement delivery options.

In some embodiments, information relating to an advertiser's target audience or advertisement delivery information is received. “Information relating to a target audience” refers to demographical, geographical, chronological or other classifications of a population and may include, for example, a target age, gender, day (e.g., weekday, weekend, etc.), or day part (e.g., afternoon, evening, etc.). “Information relating to advertisement delivery” may include, for example, advertisement type (e.g., gateway, broadcast, sponsored link, etc.), network (e.g., television network, radio network, etc.), geographic market, format, or an impression goal. The information received includes a selection of “all,” “none,” or “not applicable” for any number of criteria defining target audience or delivery options.

In some embodiments, a supplier of goods or services provides information to a system. A “supplier” can be any entity that provides goods or services to others, such as, for example, a publisher of media content or advertisements, a manufacturer, a reseller, a dealer, a vendor, a distributor, a Web site operator, a communications network provider or operator, a broadcaster, a cable system operator, a television network, a magazine publisher, a book publisher, a music publisher, a motion picture studio, a billboard owner, a leasing agent, an owner of a facility (such as a stadium, an auditorium, a trade center, an airport, a shopping mall, etc.), an internet service provider, a newspaper publisher, a digital media producer, or a provider of media hosting services (such as a service that stores and/or serves digital video, pictures, audio, text, etc.). In the context of media advertising sales, for example, a supplier may be a publisher of content that is displayed in conjunction with advertisements, such as gateway advertisements, banner advertisements, or sponsored hyperlinks.

Some embodiments include a computer-readable medium for carrying or having computer-executable instructions or data structures. A computer-readable medium can be any available medium that can be accessed by a computer. By way of example, and not limitation, such computer-readable media can comprise physical storage media such as RAM, ROM, EEPROM, CD-ROM, DVD or other optical disk storage, magnetic disk storage or other magnetic storage devices, or any other medium that can be used to carry or store computer-executable instructions or readable data. When information is transferred or provided over a network or another communications connection to a computer, the network or connection is a computer-readable medium. Combinations of the above are also included within the scope of computer-readable media. Computer-executable instructions may comprise instructions and data which cause a computer or processor to perform a certain function or group of functions.

Some embodiments will be described in the context of computer-executable instructions, such as program modules, being executed by hardware devices, such as servers, workstations, and personal computers. Program modules may include routines, programs, objects, components, data structures, etc. that perform particular tasks or implement particular data types. Computer-executable instructions, associated data structures, and program modules represent examples of program code for executing steps of the methods disclosed herein. The particular sequence of executable instructions or arrangement of associated data structures represents examples of corresponding acts for implementing the functions described in such steps.

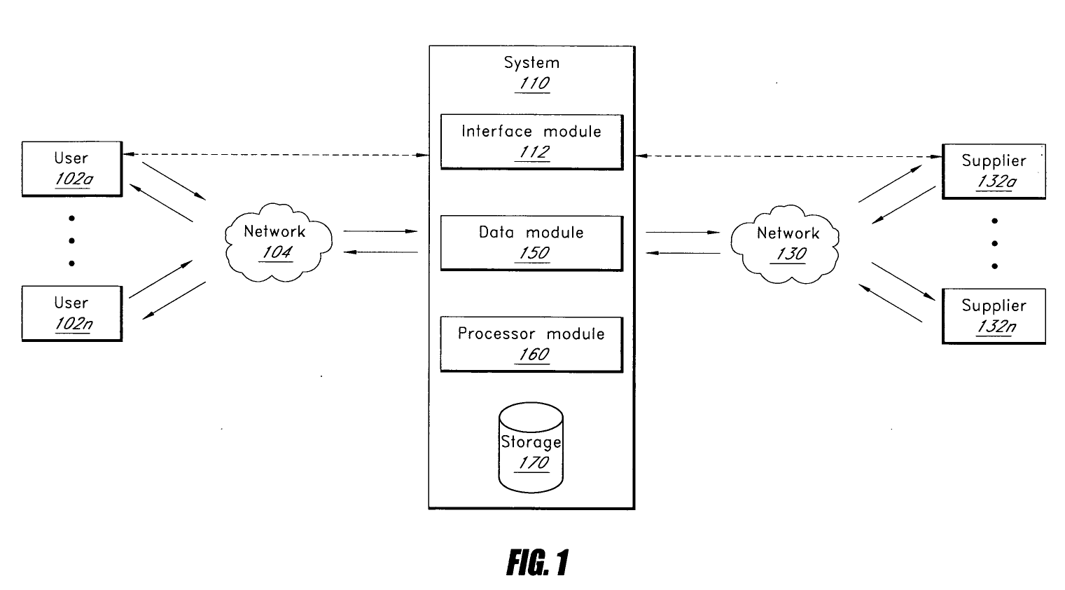

Referring now to FIG. 1, depicted is a diagram of an example system for displaying information to a user to assist the user in a purchasing decision according to an embodiment of the present disclosure. Although reference is made to the implementation of various features and functions of the present disclosure in the described environment, one skilled in the art can identify other environments that can benefit from one or more aspects of the present disclosure.

As illustrated in FIG. 1, users 102a-102n communicate with a system 110. The communication may occur through network 104, such as, for example, a wide area network, a local area network, a wireless network, the Internet, or the like. The communication between users 102a-102n and system 110 may also be direct, omitting network 104. Such a situation may occur when, for example, the system 110 resides on a computer at the same location as one or more users 102a-102n. The system 110 includes an interface module 112, a data module 150, a processor module 160, and storage 170. Suppliers 132a-132n (for example, publishers of advertisements or media content, producers of products or services, or resellers of products or services) also communicate with system 110. The communication between suppliers 132a-132n and system 110 may occur through a network 130, or the communication may be direct, omitting network 130.

The system may be designed to be used by users 102a-102n with varying levels of administrative and/or data access rights. For example, the system may include techniques that are known in the art for safeguarding sensitive information. In an advertising purchasing context, the system may be designed to be used by advertisers or their agents. Agents of an advertiser, for example, may have access to data and tools that are more restricted or limited than data and tools to which the advertiser has access.

The interface module 112 includes graphic and/or textual controls that determine the way in which the system 110 responds to user activity. The interface module 112 may include program code for displaying user prompts in order to obtain purchasing preferences from the user. The interface module 112 may also include program code for displaying interface elements, such as drop-down menus, radio buttons, multiple selection lists, text input fields, etc., that allow the user to provide criteria to filter an inventory of a product. In some embodiments, the interface module 112 comprises program code for displaying the value of one or more metrics over a period of time. The metrics may be displayed, for example, on a line chart that shows how a metric associated with a product varies over time. The chart may include more than one metric, and some metrics may only be displayed over a subset of the entire time domain represented on the chart. The line chart may, for example, show a portion of the historical value of a metric over time, the current value of the metric, and/or one or more projections of the value of the metric over a future period of time. Means for displaying metrics are not limited to a line chart. Any suitable means for showing the value of a varying statistic as a function of time, such as area charts, bar charts, scatterplots, or pictographs using any combination of color schemes, fill patterns, and shading, may be used.

The system 110 shown in FIG. 1 also includes a data module 150. The data module 150 may comprise program code for projecting the values of various metrics in the future as a function of time. For example, the data module 150 may include code for projecting future values for total inventory, available inventory, and secured inventory. In the context of media advertising placements, the projection may be made by, for example, linearly scaling historical impressions that result from identical or similar advertising orders over a comparable time period. In addition, any model or combination of models known in the art may be used to project a count of future impressions. Processor module 160 may execute the algorithms used to project future metrics. Projections of future metrics may be stored in storage 170 for later retrieval or calculated at the time the projections are required from historical data stored in storage 170 and/or current data collected by data module 150. Storage 170 may include, for example, a hard disk drive, several hard disk drives, RAM, ROM, EEPROM, CD-ROM, DVD or other optical disk storage, magnetic disk storage or other magnetic storage devices, or any other medium that can be used to carry or store computer-executable instructions or readable data.

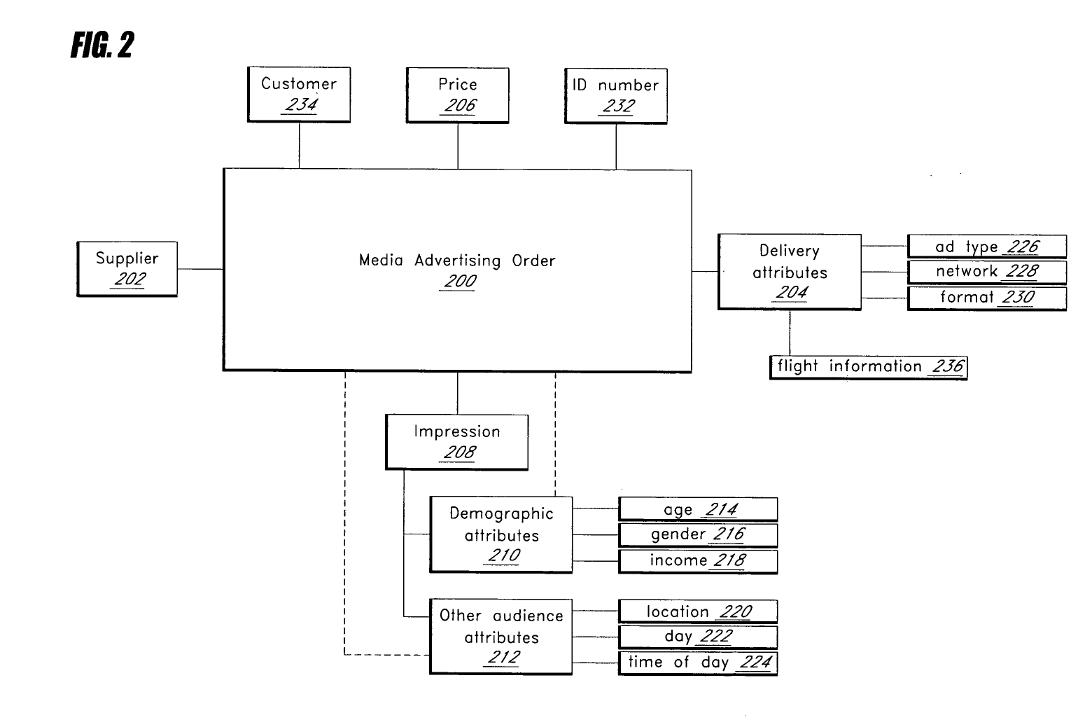

The data module 150 may include program code for obtaining measurements of metrics from suppliers 132a-132n. For example, the data module 150, may obtain measurements of metrics directly by, for example, automatically receiving data from or sending queries to suppliers continuously, regularly, or sporadically. The data module 150 may also simply receive a value that corresponds to a measurement obtained in another fashion. In some embodiments, system 110 is maintained or operated by one or more suppliers 132a-132n, in which case data module 150 may directly track metrics, such as impressions, associated with products made by one or more suppliers 132a-132n. The data module 150 may comprise program code for tracking metrics over a time interval, such as program code for counting impressions that occur during 15-minute intervals. In one embodiment, the period of time over which current impressions are measured is not more than about one day, and the relatively short period of time may be, for example, one hour, thirty minutes, fifteen minutes, or an even shorter period of time. The data module 150 may maintain measured metrics and data associated with the measured metrics in storage 170. Example varieties of data that may be associated with media advertising placements are shown in FIG. 2.

Referring now to FIG. 2, depicted is a diagram of an example structure for a media advertising order data object. A media advertising order 200 typically results in impressions 208, the magnitude of which may approximate the number of instances in which a person is exposed to an advertiser's message. An advertising impression 208 is one example of a product that can be provided by suppliers 132a-132n (FIG. 1). In some embodiments, a data module 150 may maintain information about previous, current, and future media advertising placements in a data structure similar to the structure shown for a media advertising order 200 data object in FIG. 2. Advertising order metadata may also be stored in any number of obvious variations of the data structure depicted or in any other way that is known in the art.

As shown in the diagram of FIG. 2, a media advertising order 200 may have several associated attributes. As a first example, each media advertising order 200 may be associated with a supplier 202 that provides impressions 208 to an advertiser. Alternatively, the supplier 202 may not provide advertising impressions 208 itself, but it may be a value-added reseller of impressions 208. As a second example of an attribute associated with media advertising order 200, the data structure may specify delivery attributes 204 of the order 200. For example, information relating to advertisement type 226, network 228, format 230, and flight information 236 (e.g., the duration of time for which an advertising order is live) may be delivery attributes 204 specified in the data structure.

A media advertising order 200 data object may also specify the customer 234 who purchased the order or supplies the advertisement. The customer 234 may be identified by a name or unique number or alphanumeric identifier, for example. The data object may specify the price 206 associated with the order 200, including a list price and/or a discounted price. The media advertising order 200 may also be associated with an assigned unique identification number 232.

Another example of an attribute associated with media advertising order 200 is one or more impressions 208. In one embodiment, each impression 208 is recorded as a separate record in the media advertising order 200 data object and has associated demographic attributes 210 and other audience attributes 212. In another embodiment, a group of several impressions 208 may be recorded in each record, and the group of impressions 208 may have demographic 210 and other audience attributes 212 associated with the entire group of impressions. In yet another embodiment, the impressions 208 attribute may simply include values showing a count of impressions as a function of time. In some embodiments, the media advertising order 200 may be associated with only one set of demographic attributes 210 and other audience attributes 212. Demographic attributes may include estimates of the approximate age 214 range of the audience, the approximate gender 216 of the audience, and the approximate income 218 range of the audience, for example. Other audience attributes may include the approximate location 220 of the audience, the day 222 or type of day (e.g., weekend, weekday, all days, holidays, etc.) during which the impression(s) occurred or will occur, and the time 224 or approximate time (e.g., morning, afternoon, evening, etc.) during which the impression(s) occurred or will occur.

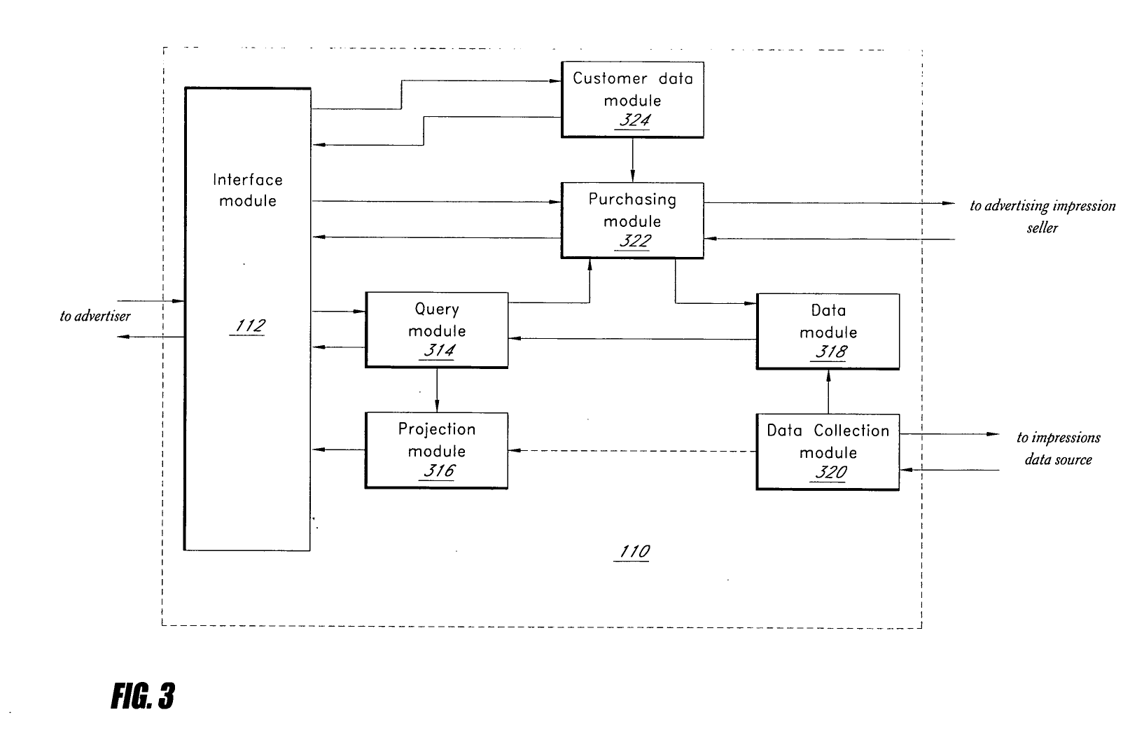

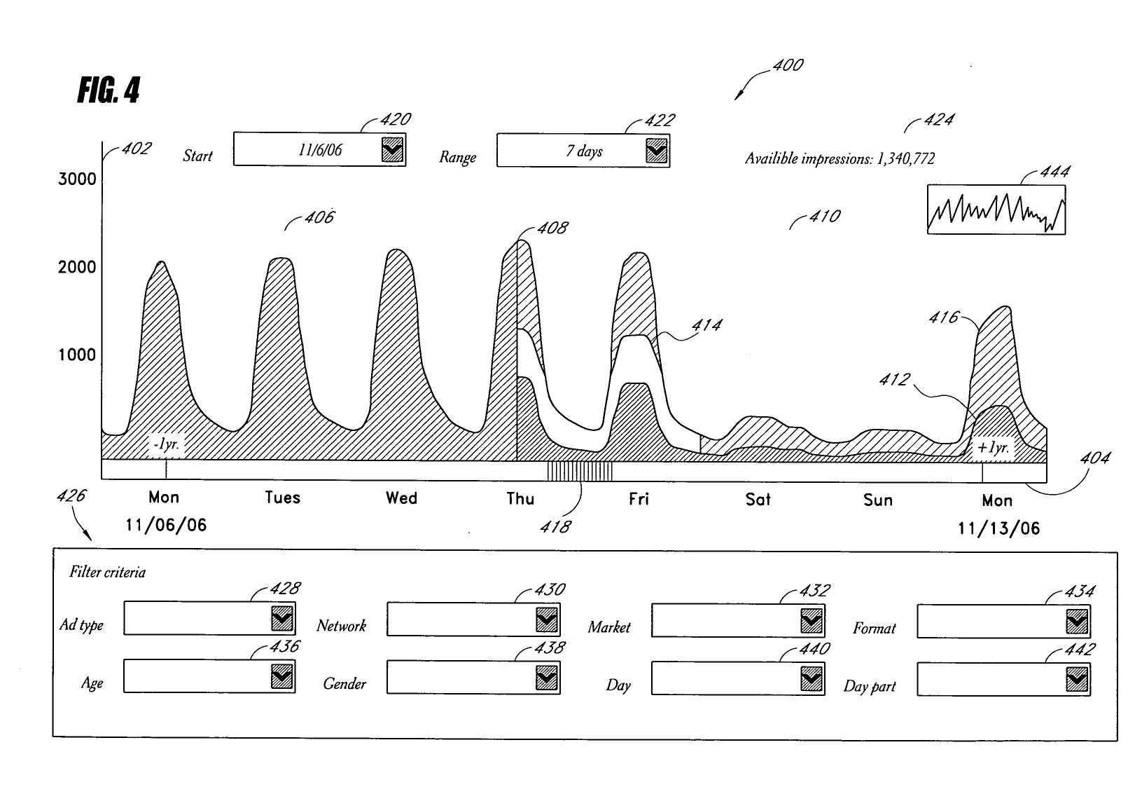

Depicted in FIG. 3 is a diagram of an example system that assists an advertiser in a media advertising purchasing decision. In the embodiment shown, a system 110 communicates with an advertiser, a seller of advertising impressions, and an impressions data source. In some embodiments, the seller of impressions and the impressions data source are the same entity. An interface module 112 serves as the primary point of interaction or communication between the system 110 and the advertiser. An example interface is shown in FIG. 4, which will be discussed in more detail later. The interface module 112 relies on program code modules in system 110, such as a customer data module 324, a purchasing module 322, a query module 314, and a projection module 316, to determine the contents of an interface displayed to the user. The interface module 112 may be linked to one or more program code modules that generate code in order to change the information that appears in the interface. The interface module 112 may comprise, for example, a Flash® application or object that a user or advertiser accesses from a web browser. In one example embodiment, the program code modules comprise PHP scripts that generate XML code, and the XML code controls a Flash® object. Such an embodiment can aid the interactivity of the interface and negates the need for a user to reload a Web page, resulting in a better user experience. Other programming languages and/or application platforms may provide better performance and/or ease of interface creation.

In alternative embodiments, the program code modules may comprise, for example, Java, ASP.NET, Javascript, CGI scripts, DHTML, or any other programming language capable of generating either web browser-readable language or instructions understood by a Flash® object or other Web-based application platform. System 110 may also be implemented as a standalone executable application accessed from a local storage device or through a network, in which case the program code modules may comprise any programming language capable of being compiled to run on a microprocessor or microcontroller.

In some embodiments, customer data module 324 includes program code for maintaining information relating to media advertising placements ordered by users of the system 110. Customer data module 324 may be responsible for identifying and/or authenticating users. For example, it may provide instructions for initial user registration and subsequent user login procedures. Code included in customer data module 324 may maintain proposed and completed media advertising placements associated with an advertiser. The module may also include program code for receiving one or more purchasing preferences of an advertiser. Purchasing preferences may include, for example, advertiser billing information and preferred target audience and advertisement delivery selections. In some embodiments, customer data module 324 stores at least some purchasing preferences in an advertiser data repository. Interface module 112 may use such purchasing preferences to provide customized default settings (e.g., filter and display options) for each user. Customer data module 324 may also provide billing or other customer information to purchasing module 322 during a media advertising purchase transaction. Customer data module 324 may include program code for allowing user 102a to switch customer accounts while using system 110 without going through a logout/login procedure and/or without user 102a having to submit to additional authentication.

In the embodiment shown in FIG. 3, purchasing module 322 includes program code for accumulating impression inventory and/or fulfilling media advertising placements. In order to accumulate impression inventory to be sold to advertisers, purchasing module 322 may submit requests for impression inventory to advertising impression suppliers. Alternatively, purchasing module 322 may comprise program code to receive impression inventory reports from suppliers (for example, from publishers). An administrator of system 110 may also simply enter impression inventory data into purchasing module 322. In any of the foregoing embodiments, impression inventory data may be accompanied by metadata of the type described in FIG. 2 in the context of a media advertising order 200 data object.

In order to fulfill a purchase request submitted by a user, purchasing module 322 may comprise program code for receiving a purchasing instruction communicated through interface module 112 and obtaining advertiser purchasing preferences from customer data module 324. In some embodiments, purchasing module 322 may obtain target audience and/or advertisement delivery preferences from interface module 324. Purchasing module 322 may also obtain target audience preferences, advertisement delivery preferences, and/or a selection of one or more proposed media advertising placements from query module 314. In some embodiments, purchasing module 322 is capable of fulfilling a purchase instruction immediately after a user communicates the instruction through interface module 112. For example, purchasing module 322 may access stored purchasing preferences from an advertiser data repository and use the stored purchasing preferences to purchase for an advertiser at least a portion of a selection of one or more proposed media advertising placements. In one embodiment, after configuring temporal and demographic parameters, a single click can complete the purchase or secure the impressions. In one embodiment, a single interface includes at least most of the tools an advertiser typically uses to complete an order process.

After a purchase instruction is fulfilled by, for example, purchasing selected media advertising placements or securing a portion of available impression inventory, purchasing module 322 may send attributes of the selected media advertising placements to data module 318. Data module 318 may then reorganize, compress, and/or store at least some of the received data in an advertising order repository. Such a repository may include records of the type shown in FIG. 2 or any other suitable data structure known in the art. Data module 318 may also maintain records of available inventory in a format similar to that used to maintain advertising order information or any other suitable format.

The system 110 shown in FIG. 3 includes a query module 314. Query module 314 may implement a database query language such as SQL in order to filter information received from data module 318. In some embodiments, query module 314 may receive, for example, target audience or advertisement delivery preferences from a user through interface module 112. Query module 314 may use such preferences to generate a request to filter information to be displayed in interface module 112. In some embodiments, a user operates an element implemented by interface module 112 to generate a request. Query module 314 interprets the request to create an SQL command (e.g., a database query). Query module 314 may also interpret the request into any other database query language. Query module 314 executes the database query to select records from one or more data repositories created by data module 318. Query module 314 may comprise program code that proceeds to generate instructions for interface module 112 to display at least a portion of the data from the records selected and/or pass data from selected records to projection module 316 for further processing.

In some embodiments, projection module 316 comprises program code for projecting future impression inventory, future proposed impressions, and/or future secured impressions. Projection module 316 may generate projections using historical impressions data, and, in some embodiments, it may also use current impressions data received from data collection module 320. In one embodiment, a linear trend algorithm may be used to determine future projected impression counts. In alternative embodiments, a neural network algorithm can be used to calculate future projected impressions. The algorithm may account for various factors that may be expected to influence advertising impressions, such as variance among different days of the week, different times of the day, and aberrations caused by holidays and the like. For example, such factors may be accounted for in future projections by projecting from previous time periods that were subject to the same or similar factors. Any other suitable projection algorithm known in the art may be used by projection module 316.

The system 110 shown in FIG. 3 includes a data collection module 320. Data collection module 320 comprises program code for obtaining a measurement of current impressions that result from one or more media advertising placements. Data collection module 320 may collect impression data from an impressions data source using any collection technique described in the previous description of data module 150 (FIG. 1). In the embodiment shown in FIG. 3, data collection module 320 sends impression counts and/or associated attributes of the impression(s) to data module 318 for possible reorganization, compression, filing, and/or storage. In some embodiments, data collection module 320 may also pass current impression count data and/or impression attributes to projection module 316 for use in a future impression projection calculation. The source of impressions data may be the same as the seller of the advertising impressions or may be an independent data source, including an administrator of system 110.

FIG. 4 shows an example embodiment of an interface 400 that presents metrics to an advertiser. Interface 400 comprises a chart having a first axis 402 representing a number of impressions during a period and a second axis 404 representing time. For example, the first axis 402 can represent a count of impressions that occur in about a fifteen-minute interval, but the interval could also be any reasonably convenient period over which to track impressions. In one embodiment, a user of the interface 400 may set or otherwise determine the interval length of the first axis 402. For example, the interval may be set to a default length of fifteen minutes, which length may be changed by the user to a preferred increment. One or more lines and/or areas on the chart represent a number of impressions as a function of time. In the embodiment shown, a first portion 406 of the chart shows historical impressions over a period of time, a second portion 408 of the chart shows current impressions, and a third portion 410 of the chart shows projected future impressions over a period of time.

The third portion 410 of the chart demonstrates how multiple lines and/or areas may be shown in combination over a selected interval of the time domain of the chart. In this portion of the chart, which corresponds to a future period of time, a first curve 412 represents a projection of future secured impressions as a function of time. First curve 412 may also include impressions that are otherwise unavailable to the advertiser (e.g., because the impressions were secured by someone else). Meanwhile, a second curve 414 corresponds to a projection of future proposed impressions, and a third curve 416 corresponds to a projection of future total impression inventory. Curves 412, 414, 416 may be differentiated using different colors or fill patterns, and curves 412, 414, 416 may be identified in a corresponding legend.

Interface 400 may comprise a slider control 418 that modifies the time axis domain. For example, a user may use a mouse to click and drag slider control 418 to the left in order to look at impression data further into the past or to the right in order to look at impression data further into the future. The slider control 418 is an element of interface 400 that operates by changing the periods over which various curves 412, 414, 416 on the chart are represented without changing the scale of the time axis 404.

In the embodiment shown in FIG. 4, interface 400 comprises a start date control 420 and a reporting range control 422. Start date control 420 is an interface element that allows the user to change the time period represented on time axis 404. Reporting range control 422 is an interface element that allows the user to change the scale of time axis 404. The reporting range control 422 operates by changing the length of the period of time represented on the time axis 404.

Interface 400 may comprise an available impressions indicator 424. The available impressions indicator may show a calculation of the difference between the projected future total impression inventory shown on the chart and the projected future secured or unavailable impressions on the chart. Alternatively, the available impression indicator may display a projection of total impression inventory available for the advertiser to reserve. The projection of total available impression inventory may change, for example, depending on filter criteria 426 selected by a user.

Filter criteria 426 are interface elements that allow a user to restrict the information displayed in interface 400 to certain target audiences and/or certain advertisement delivery options. For example, filter criteria 426 relating to advertisement delivery options may include advertisement type, network, market, and format. Thus, interface 400 may comprise corresponding controls 428, 430, 432, 434 for these example options. Data may also be filtered by target audience attributes, such as age, gender, day, and day part, as described above. Interface 400 may comprise corresponding controls 436, 438, 440, 442 for these example attributes.

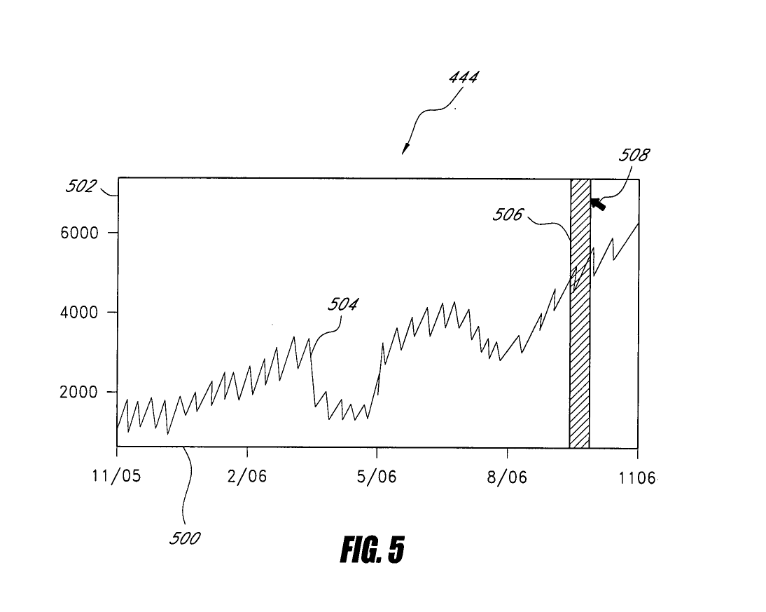

The embodiment shown in FIG. 4 includes a second chart 444 that displays impression data over a comparatively long period of time when compared to the period represented by the time axis 404 of the first chart. In a preferred embodiment, second chart 444 provides at least about a year's worth of impression data, allowing a user to quickly jump to a particular time in the impression history to view the data more closely. Second chart 444 is shown in more detail in FIG. 5.

FIG. 5 shows an embodiment of an interface element 444 including a zoomed-out view of advertising impressions over time. Interface element 444 comprises a first axis 502 representing a number of impressions within an interval of time and a second axis 500 representing time. First axis 502 may have units that are different from those for y-axis 402 (FIG. 4). For example, first axis 502 may represent a count of impressions with about a one-day interval or a one-hour interval rather than a shorter interval. Alternatively first axis 502 may use the same units as y-axis 402. In one embodiment, second axis 500 extends over a period of time longer than the period represented by default on x-axis 404. For example, second axis 500 may represent about six months of time or longer, whereas x-axis 404 may represent by default about two weeks of time or less.

Interface element 444 includes a curve 504 representing historical, current, and/or future impressions as a function of time. The effect of using units for first axis 502 different from those used for y-axis 402 may be to make curve 504 smoother in appearance and more readable than if the same units were used. Interface element 444 may include a shaded region 506 indicating the portion of data that is shown in the first chart (e.g., the zoomed-in impression count view) in FIG. 4. The region may be demarcated by any other suitable means known in the art and not just by shading. In some embodiments, a user may change the start date and/or reporting range of the impressions data in the first chart by selecting a portion of the shaded region 506 with a cursor 508 and dragging and/or extending the shaded region along the first axis 502 within interface element 444. Alternatively, a user may change the start date and/or reporting range of the impressions data in the first chart by clicking on the shaded region 506 with cursor 508 and moving the shaded region to another position along first axis 502.

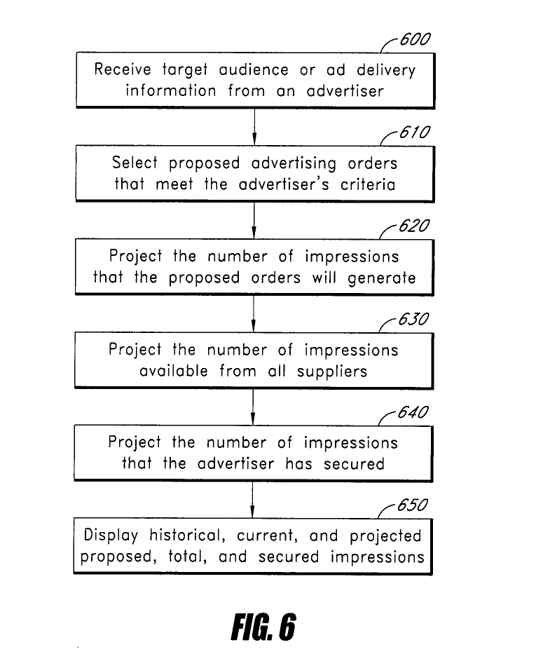

In FIG. 6 is shown a flowchart exemplifying the operation of a system that presents metrics to an advertiser according to certain embodiments of the present disclosure. The order of steps presented is by way of example only. At 600, interface module 112 (FIGS. 1, 3) receives information relating to a target audience and/or advertisement delivery from a user 102a, such as an advertiser. Such information may be received during an initial user registration process of a type that is known in the art or at the time that the user 102a interacts with system 110 by, for example, using interface elements 426 (FIG. 4) to select criteria by which to filter data displayed by the interface module 112.

At 610, query module 314 (FIG. 3) generates commands to select proposed advertising orders from the inventory of available impressions maintained by purchasing module 322. The commands are generated in such a way that the selected orders meet the advertiser's criteria, which are received from customer data module 324 (e.g., if the criteria are taken from the advertiser's saved purchasing preferences) and/or from interface module 112 (e.g., if the advertiser has used interface elements to select particular advertisement delivery attributes 336, 338, 340, 342, target audience attributes 328, 330, 332, 334, and/or one or more time periods). In some embodiments, query module 314 may create instructions for interface module 112 to display a list of the selected proposed advertising orders with order attributes returned from the query.

At 620 of FIG. 6, projection module 316 (FIG. 3) projects the number of future impressions that the selected proposed advertising orders will generate. Query module 314 may select relevant historical data from data module 318 required by program code within projection module 316 that implements a future advertising order impression projection algorithm. For example, query module 316 may create a query for previous media advertising placements that took place during similar time periods, were targeted to similar audiences, and were delivered in similar formats or through similar channels. Query module 314 may thereafter send the selected historical data to projection module 316. Data collection module 320 may also supply projection module 316 with relevant current advertising impression measurements. Projection module 316 executes a function that converts the selected historical data and/or relevant current advertising impression data into a projection of future proposed impressions.

At 630 of FIG. 6, projection module 316 (FIG. 3) projects the inventory of impressions available from all suppliers 132a-132n (FIG. 1). Query module 314 may, for example, generate a command to select impression inventory that meets certain target audience criteria. Alternatively, query module 314 may select the total impression inventory. Impression inventory comes from suppliers 132a-132n, from whom historical impression data may be already known. Query module 314 sends impression inventory data and/or historical impression data associated with current impression inventory to projection module 316. Projection module 316 uses the received data to project future available inventory for all suppliers. For example, projection module 316 may use an algorithm that extrapolates from historical impression performance of the supplier. In some embodiments, projection module 316 may need to only forward impression inventory data to interface module 112.

At 640 of FIG. 6, projection module 316 projects the number of future impressions that the user 102a (e.g., the advertiser) has already secured. Query module 314 may generate a query to select impression inventory and/or media advertising placements that customer data module 324 has identified as secured by the advertiser. Query module 314 sends secured impression data and/or historical impression data associated with the suppliers from whom impressions are secured to projection module 316. Projection module 316 uses the received data to project future secured impressions. For example, projection module 316 may use an algorithm that extrapolates from historical impression performance of suppliers from whom impressions have been secured. In some embodiments, projection module 316 may need to only forward secured impression data to interface module 112.

At 650, interface module 112 displays historical impression data, current impressions, and projected future impressions data that meet criteria supplied by the advertiser at 600. Projected future impressions may include proposed impressions, available impression inventory, and secured impressions. Query module 314 may generate code to cause interface module 112 to display historical impression data and current impressions that meet criteria selected by the advertiser. Projection module 316 may generate code to cause interface module 112 to display future impression projections that it has made at 620, 630, and 640, including proposed impressions, available impression inventory, and secured impressions.

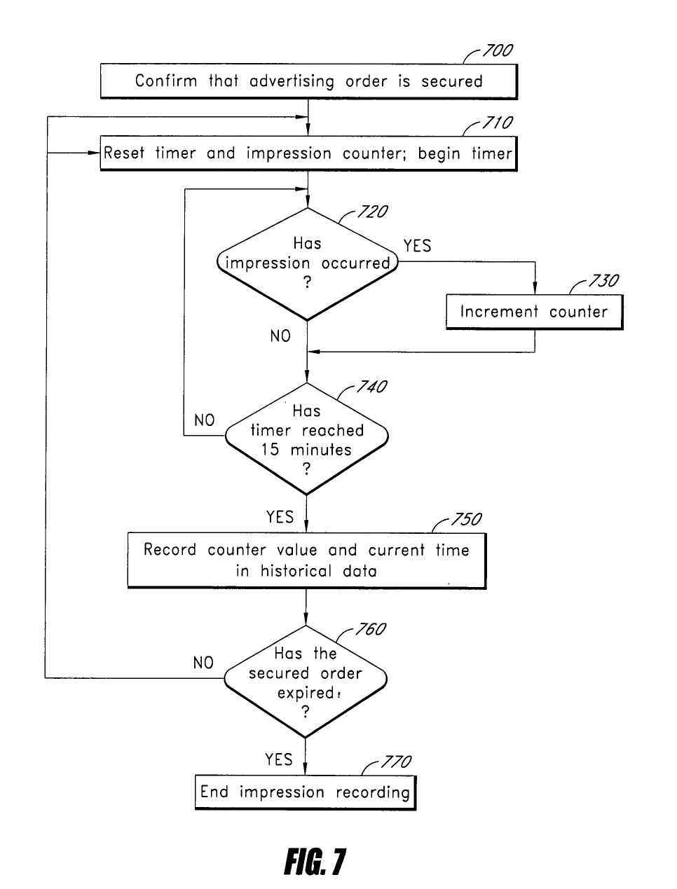

Turning now to FIG. 7, depicted is an embodiment of a method for maintaining a record of historical impressions. In the embodiment shown, data collection module 320 (FIG. 3) counts impressions as they occur. However, in alternative embodiments, data collection module 320 may receive, for example, periodic measurements of impressions from an impression data source such as the advertising impression supplier. In such embodiments, data collection module 320 may simply instruct data module 318 to record impression measurements as they are received.

At 700, data collection module 320 receives a confirmation that a media advertising order is secured and an instruction to begin tracking impressions associated with the advertising order. After purchasing module 322 fulfills a purchasing instruction, it may instruct data module 318 to flag associated advertising orders and/or impression inventory as secured by an advertiser. Once a secured advertising order becomes active, data module 318 may instruct data collection module 320 to begin counting advertising impressions or receiving impression statistics. Data module 318 may also pass an advertising order expiration time and date to data collection module 320.

At 710, data collection module 320 initializes or resets a timer and an impression counter. After being initialized, the timer operates continuously during the remaining steps of the procedure. While the timer reports that less than fifteen minutes have elapsed, data collection module 320 watches for impressions at 720. When data collection module 320 receives a signal—for example, from an impressions data source—that an impression has occurred, data collection module 320 increments the impression counter at 730. Data collection module 320 will continually check for signals that impressions have occurred until the timer reaches fifteen minutes (step 740). Data collection module 320 may also report an intermediate count of current impressions to projection module 316. In some embodiments, projection module 316 may use impression data received from data collection module 320 to determine the number of current impressions 408 (FIG. 4) to be shown in interface 400 and/or to project future impressions 410.

When data collection module 320 detects that the timer has reached fifteen minutes at 740, it may record the value of the impression counter and the time and date when the impression data was recorded (step 750). Although a fifteen-minute interval is the period used to determine the frequency of impression count recording in this embodiment, other time intervals, such as five minutes, thirty minutes, an hour, or a day may also be used as the time interval under appropriate circumstances. Smaller time intervals may be preferable because longer time interval impression data can be calculated or projected accurately from impression data recorded at shorter time intervals. Historical impression data may be recorded by adding it to a data object associated with an advertising order, as shown in FIG. 2, and/or may be simply saved to a historical data repository including historical impression data as a function of time.

At 760, data collection module 320 determines whether the advertising order that is generating the impressions being counted has expired. If the order has not expired, data collection module 320 returns to step 710, where the timer and impression counter are reset and impressions are counted for another period. If data collection module 320 determines that the advertising order has expired, it reaches step 770, where impression recording ceases. At 770, data collection module 320 may pass a record of impression data as a function of time to data module 318 for storage and/or further processing.

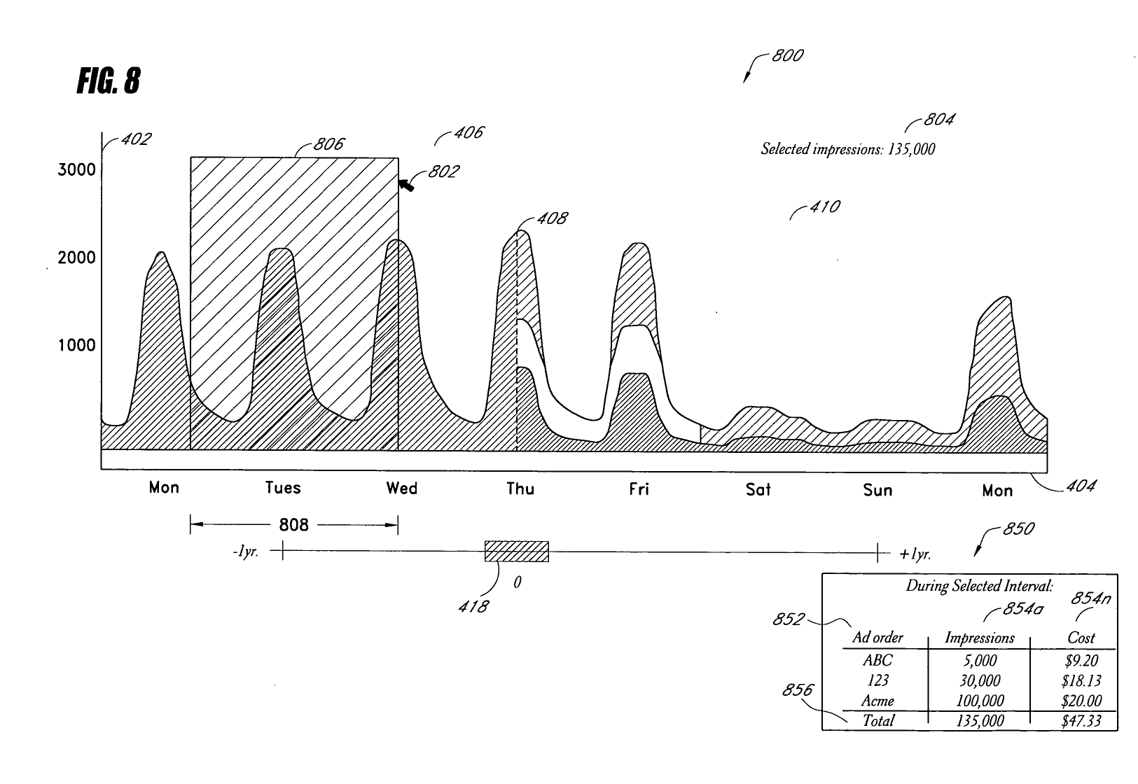

FIG. 8 shows an embodiment of an interface 800 that displays attributes of historical advertising orders. Interface 800 includes many of the features shown in interface 400 (FIG. 4). For example, interface 800 comprises a chart having a first axis 402 representing a number of impressions during a period and a second axis 404 representing time. In one embodiment, the first axis 402 represents a count of impressions that occur in about a fifteen-minute interval, but the interval could also be any reasonably convenient period over which to track impressions. One or more lines and/or areas on the chart represent a number of impressions as a function of time. In the embodiment shown, a first portion 406 of the chart shows historical impressions over a period of time, a second portion 408 of the chart shows current impressions, and a third portion 410 of the chart shows projected future impressions over a period of time. A slider 418 allows adjustment of the domain of time axis 404.

Interface 800 additionally comprises a selected area 806. Selected area 806 may be created, for example, when a user points a cursor 802 at a position corresponding to a time indicated along the second axis 404 of the chart. The user clicks a mouse and drags cursor 802 generally horizontally along the chart to create selected area 806. Selected area 806 corresponds to a selected time period, which may be defined as the period 808 represented along the second axis 404 delimited by the vertical edges of selected area 806. As a more specific example, in the embodiment shown in FIG. 8, if the day labels along second axis 404 are centered at 12:00 p.m. on the day indicated, selected time period 808 corresponding to selected area 806 extends from Monday afternoon until Wednesday at about noon. In the embodiment shown in FIG. 8, selected time interval 808 and selected area 806 are entirely within the first portion 406 of the chart, which shows historical impressions as a function of time. Selected area 806 may be indicated in interface 800 by a shaded region on the graph, by a contrasting coloration within the selected area, by a rectangle encompassing the area selected, or by any other suitable means known in the art for indicating a selected region.

Interface 800 may comprise a selected impressions indicator 804 that displays the number of advertising impressions within selected time interval 808. Selected impressions indicator 804 may display the number of impressions as a text number, graphically, or by any other suitable means known in the art for communicating a number to a user of an interface. The number of selected impressions may be calculated, for example, by summing the impression count data points within selected time interval 808.

Interface 800 may also comprise an interface element that displays attributes of historical advertising orders within selected time interval 808. The interface element shown in FIG. 8 is a table 850 listing advertising orders by name 852 with their associated attributes 854a-854n. Associated attributes may include, for example, a number of impressions 854a contributed to the total selected impressions 804, a cost 854n associated with the advertising order and/or the selected number of impressions within the advertising order, advertisement delivery options such as ad type, network, market, format, and any other number of advertising order attributes discussed herein (e.g., during the discussion of FIG. 2) or otherwise known in the art. The table 850 may expand vertically if multiple advertising orders contributed to the historical impressions within selected time interval 808. Table 850 may optionally comprise a row of totals 856 that provides a sum of certain attributes 854a-854n, where appropriate. Table 850 may be displayed at any appropriate position in interface 800, for example, below the chart and chart modification elements. In some embodiments, table 850 may be displayed in a separate window, such as a pop-up window. For example, a window including table 850 may appear on a user's monitor when an element within interface 800 such as a text link or button is operated by a user.

In some embodiments, attributes of historical orders may also include performance information, such as, for example, the number of “clickthrus” (the number of advertisement viewers who follow a hyperlink attached to the advertisement), if applicable, as well as conversion information. Conversion information indicates that a person who saw an advertisement made some action and can correlate with the success of an advertisement campaign. The performance information can also include return on investment, for example, as a ratio of the revenue generated by the order over the cost of the order. Such performance information can be combined with temporal and/or demographic parameters to help an advertiser determine the audience (for example, the gender, the age, etc.) and/or the time (for example, the hour of day, the day of the week, etc.) to which future advertisements should be targeted. Advertisement impressions can be correlated with purchases or other actions using, for example, a cookie-based system in which an advertiser places a software module (for example, a segment of code) on a website to accomplish communication within a trafficking system.

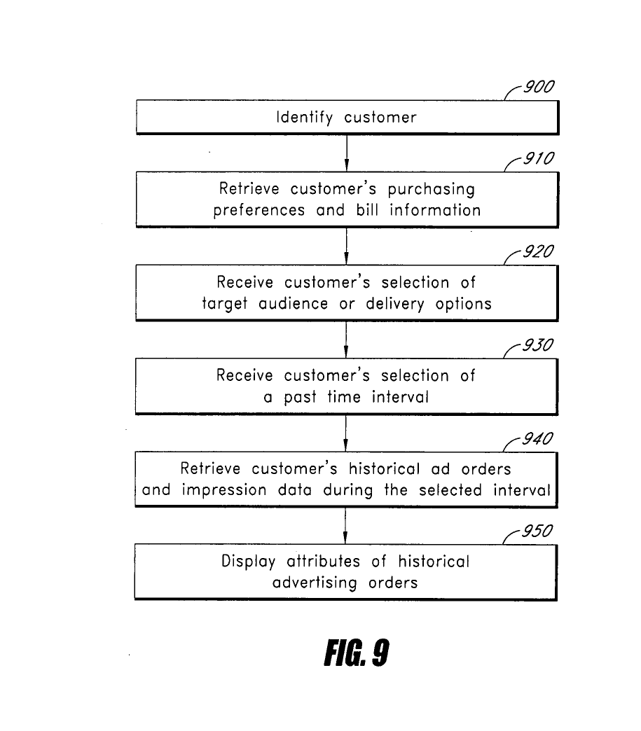

FIG. 9 is a flowchart exemplifying the operation of a system that displays attributes of historical advertising orders according to certain embodiments of the present disclosure. At 900, customer data module 324 (FIG. 3) identifies a customer by executing an initial user registration procedure or a returning user login procedure, as described previously. In some embodiments, step 900 may occur when a user 102a (FIG. 1) first accesses system 110, for example, by navigating to a Web page created by interface module 112.

At some point after the customer is identified, customer data module 324 may retrieve purchasing preferences and/or billing information of the customer that has previously been saved within system 110 (step 910). The purchasing preferences and/or billing information may include criteria that filter the advertising orders that will be displayed. At 920, interface module 112 may receive instructions from the user to select advertising orders that meet certain target audience and/or advertisement delivery criteria. In some embodiments, filter criteria communicated to interface module 112 may override criteria specified in an advertiser's purchasing preferences, which are maintained by customer data module 324. For example, if an advertiser's purchasing preferences indicate that it is only interested in impression inventory that reaches an audience in New York City, a user's selection of Newark, N.J., as an additional target audience within interface 400 (FIG. 4) may override the advertiser's default purchasing preferences.

In some embodiments, user accounts can be limited to certain territories based on supplier requirements such as, for example, contractual obligations. For example, some publishers may be selective regarding the advertisers that are allowed to obtain traffic from their properties. As another example, some advertisers may be able to obtain exclusive rights to properties. Other publisher and/or advertiser arrangements may also affect advertisement delivery and/or targeting options. In one embodiment, customer data module 324 includes territory restrictions that are flexible and/or dynamic in their ability to accommodate business requirements that may arise.

At 930, interface module 112 receives a user's selection of a time interval 808 (FIG. 8) within the portion of the chart 406 that represents historical impressions as a function of time. Time interval 808 is associated with a selected area 806 within interface 800 that is created by the user 102a using any suitable means known in the art for making a selection.

At 940, query module 314 creates a query to select advertising orders of the customer that generated the impressions that occurred during selected time interval 808. Query module 314 may also retrieve historical impression data from the selected interval 808, if such data is not already associated with the selected advertising orders (e.g., within an advertising order data object and/or as advertising order metadata). The query created by query module 314 may be restricted to advertising orders and impression data that meet the advertiser's target audience and/or advertisement delivery criteria. Thus, selected advertising orders and impression data may be restricted to time interval 808, purchasing preferences provided by customer data module 324, and/or criteria communicated by user 102a to interface module 112.

At 950, query module 314 sends the selected advertising orders and impression data to interface module 112 for display. Interface module 112 may thereafter update interface 800 to include a listing 850 of advertising orders that contributed to impressions during the selected time interval 808. Interface module 112 may also display various attributes of the selected advertising orders in the listing 850. Such attributes may be, for example, selected by user 102a and/or stored in an advertiser's purchasing preferences.

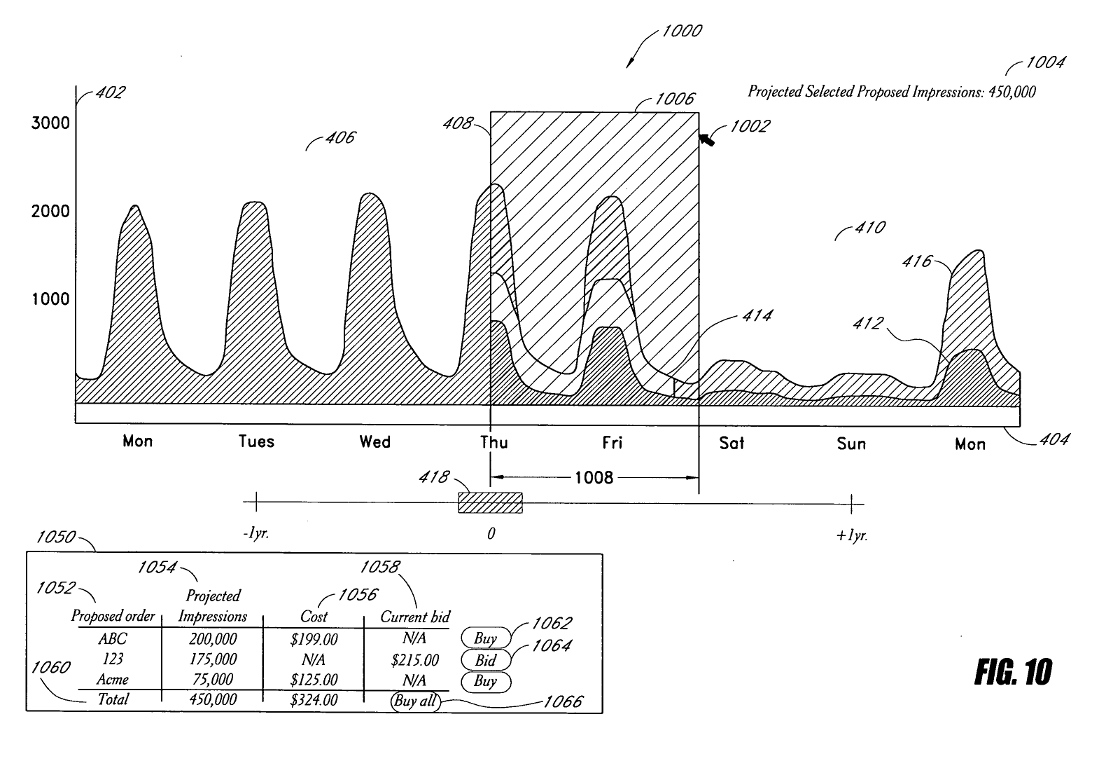

In FIG. 10 is illustrated an embodiment of an interface that displays information pertaining to future advertising orders. Interface 1000 includes many of the features shown in interface 400 (FIG. 4). For example, interface 1000 comprises a chart having a first axis 402 representing a number of impressions per unit of time and a second axis 404 representing time. One or more lines and/or areas on the chart represent a number of impressions as a function of time. A first portion 406 of the chart shows historical impressions over a period of time, a second portion 408 of the chart shows current impressions, and a third portion 410 of the chart shows projected future impressions over a period of time. A slider 418 allows adjustment of the domain of time axis 404.

Interface 1000 additionally comprises a selected area 1006. Selected area 1006 may be created, for example, when a user points a cursor 1002 at a position corresponding to a time indicated along the second axis 404 of the chart. The user clicks a mouse and drags cursor 1002 generally horizontally along the chart to create selected area 1006. Selected area 1006 corresponds to a selected time period, which may be defined as the period 1008 represented along the second axis 404 delimited by the vertical edges of selected area 1006. As a more specific example, in the embodiment shown in FIG. 10, if the day labels along second axis 404 are centered at 12:00 p.m. on the day indicated, selected time period 1008 corresponding to selected area 1006 extends from Thursday at about noon until Friday at about midnight. In the embodiment shown in FIG. 10, selected time interval 1008 and selected area 1006 are entirely within a portion 410 of the chart that shows projected future impressions as a function of time. Selected area 1006 may be indicated in interface 1000 by a shaded region on the graph, by a contrasting coloration within the selected area, by a rectangle encompassing the area selected, or by any other suitable means known in the art for indicating a selected region.

Like interface 400 in FIG. 4, interface 1000 comprises portion 410 of the chart that demonstrates how multiple lines and/or areas may be shown in combination over a selected interval of the time domain of the chart. In portion 410 of the chart, a first curve 412 represents a projection of future secured impressions as a function of time. First curve 412 may also include impressions that are otherwise unavailable to the advertiser (e.g., because the impressions were secured by someone else). Second curve 414 corresponds to a projection of future proposed impressions. In some embodiments, second curve may be shown only within selected area 1002. For example, the selection of proposed impressions and/or advertising orders may be limited to time interval 1008. Third curve 416 corresponds to a projection of future impression inventory.

Interface 1000 may comprise a selected projected impressions indicator 1004 that displays the projected number of impressions within selected time interval 1008. Selected projected impressions indicator 1004 may display the quantity of projected available impression inventory within selected time interval 1008, the number of projected proposed impressions within time interval 1008, and/or the number of projected secured impressions within time interval 1008. User 102a (FIG. 1) may have the option of changing how many or which of the foregoing values are displayed by selected projected impressions indicator 1004. The number of projected impressions may be calculated, for example, by summing the projected inventory, proposed impressions, or secured impressions data points within selected time interval 1008. Selected impressions indicator 1004 may display the number of impressions as a text number, graphically, or by any other suitable means known in the art for communicating a number to a user of an interface.

Interface 1000 may also comprise an interface element that displays information pertaining to future proposed and/or completed advertising orders within selected time interval 1008. The interface element shown in FIG. 10 is a table 1050 listing proposed and/or completed advertising orders by name 1052 with selected attributes that are associated with the proposed and/or completed advertising orders. Associated attributes of such advertising orders may include, for example, a number of projected impressions 1054, a cost 1056 or purchase price associated with the advertising order and/or the selected number of impressions within the advertising order, a current bid amount 1058 (when applicable), advertisement delivery options such as ad type, network, market, format, impression goal, and any other advertising order attributes discussed herein (e.g., during the discussion of FIG. 2) or otherwise known in the art.

Table 1050 may also comprise a buy button 1062 that allows user 102a to create an instruction to purchase a proposed advertising order and/or a certain number of impressions. In some cases, table 1050 may comprise a bid button 1064 that creates an instruction to bid on a proposed advertising order and/or a certain number of impressions. Purchasing module 322 (FIG. 3) may comprise program code for immediately purchasing or bidding on an advertising order when user 102a clicks buy button 1062 or bid button 1064. Table 1050 may expand vertically if multiple proposed or completed advertising orders contributed to the projected impressions within selected time interval 1008. Table 1050 may optionally comprise a row of totals 1060 that provides a sum of certain attributes within table 1050, where appropriate. Table 1050 may also comprise a buy all button 1066 that creates an instruction to purchase all of the proposed advertising orders and/or impressions available for purchase within table 1050.

Table 1050 may be displayed at any appropriate position in interface 1000, for example, below the chart and chart modification elements. In some embodiments, table 1050 may be displayed in a separate window, such as a pop-up window. For example, a window including table 1050 may appear on a user's monitor when an element within interface 1000 such as a text link or button is operated by a user.

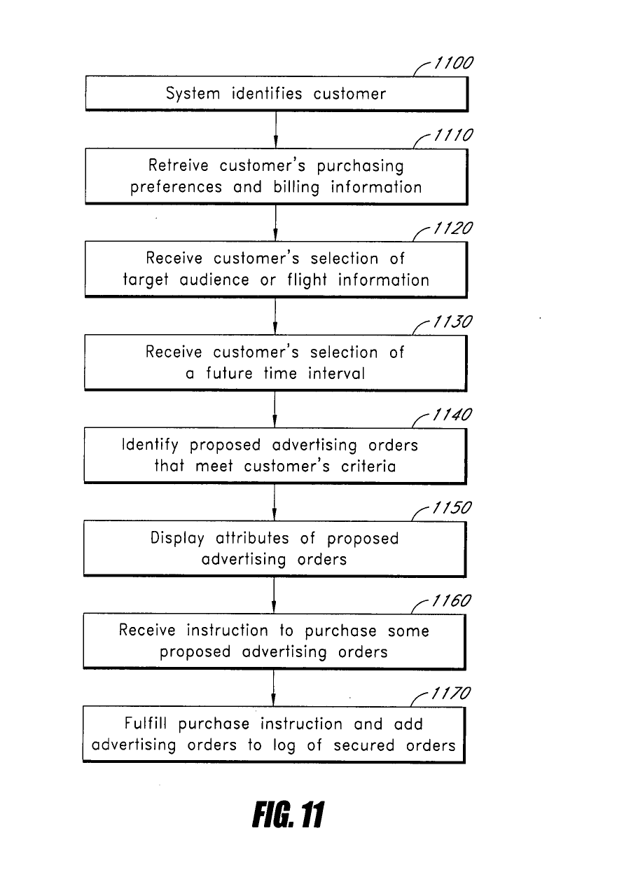

FIG. 11 is a flowchart exemplifying the operation of a system that displays information pertaining to proposed advertising orders and fulfills media advertising purchase instructions according to certain embodiments of the present disclosure. At 1100, customer data module 324 (FIG. 3) identifies a customer by executing an initial user registration procedure or a returning user login procedure, as described previously. In some embodiments, step 1100 may occur when a user 102a (FIG. 1) first accesses system 110, for example, by navigating to a Web page having an object operated by interface module 112.

At some point after the customer is identified, customer data module 324 may retrieve purchasing preferences and/or billing information of the customer that has previously been saved within system 110 (step 1110). The purchasing preferences and/or billing information may include criteria that filter the advertising orders that will be displayed and/or purchased. At 1120, interface module 112 may receive instructions from the user to select advertising orders that meet certain target audience and/or advertisement delivery criteria. In some embodiments, filter criteria communicated to interface module 112 may override criteria specified in an advertiser's purchasing preferences, which are maintained by customer data module 324.

At 1130, interface module 112 receives a user's selection of a time interval 1008 (FIG. 10) within the portion of the chart 410 that represents future projected impressions as a function of time. Time interval 1008 is associated with a selected area 1006 within interface 1000 that is created by the user 102a using any suitable means known in the art for making a selection.

At 1140, query module 314 creates a query to select proposed and/or completed advertising orders that will generate the impressions that are projected to occur during selected time interval 1008. Query module 314 may also retrieve projected impression inventory data from the selected interval 1008, if such data is not already associated with the selected advertising orders (e.g., within an advertising order data object and/or as advertising order metadata). Query module 314 may rely on projection module 316 to generate future projections of impressions from historical and/or current impression data as they are needed. The query created by query module 314 may be restricted to advertising orders and impression data that meet the advertiser's target audience and/or advertisement delivery criteria. Thus, selected proposed and/or completed advertising orders and impression data may be restricted to time interval 1008, purchasing preferences provided by customer data module 324, and/or criteria communicated by user 102a to interface module 112.

At 1150, query module 314 sends the selected proposed and/or completed advertising orders and impression data to interface module 112 for display. Interface module 112 may thereafter update interface 1000 to include a listing 1050 of proposed and completed advertising orders that will contribute to impressions that are projected to occur during selected time interval 1008. Interface module 112 may also display various attributes of the selected advertising orders in the listing 1050. Such attributes may be, for example, selected by user 102a and/or stored in an advertiser's purchasing preferences.

At 1160, interface module 112 receives an instruction to purchase one or more proposed advertising orders. For example, user 102a may click on buy button 1062 or buy all button 1066 within interface 1000. Interface module 112 may forward the purchasing instruction to purchasing module 322. Alternatively, interface module 112 may receive an instruction to bid on one or more proposed advertising orders (e.g., orders for which an option to bid is available). Interface module 112 may forward the instruction to bid to purchasing module 322. The scope of the instruction to purchase or instruction to bid may be governed by time interval 1008, purchasing preferences provided by customer data module 324, and/or criteria communicated by user 102a to interface module 112.

At 1170, purchasing module 324 fulfills an instruction to purchase or bid for one or more proposed advertising orders. Purchasing module 324 instructs interface module 112 to acquire from user 102n additional information, if any, which is required to complete the purchase or bid. In some embodiments, user 102a may have already agreed to terms and provided purchasing details that allow purchasing module 322 to proceed to immediately purchase or bid on the selected one or more proposed advertising orders without subsequent user actions. Purchasing module 322 may communicate at least some of the bid or purchase information to an advertising impression supplier. Purchasing module 322 may then waits for a purchase or bid confirmation from the advertising impression supplier. After purchasing module 322 receives confirmation that an advertising order is secured, purchasing module 322 may instruct data module 318 to record that user 102a has secured the advertising order. Data module 318 may thereafter instruct data collection module 320 to begin counting impressions that result from the secured advertising order at the appropriate time. Purchasing module 322 may also instruct interface module 112 to display to the user an indication that the one or more requested advertising orders were purchased and/or update interface 1000 to reflect that additional projected future impressions have been secured.

Various embodiments of the present disclosure have been shown and described. Some alternative embodiments and combinations of embodiments disclosed herein have already been mentioned. Additional embodiments comprise various other combinations or alterations of the embodiments described. Those skilled in the art will appreciate that changes may be made in described embodiments without departing from the ambit of the invention, the scope of which encompasses at least the claims and their equivalents.

What is claimed is:

1. A method of providing advertising metrics in order to assist in media advertising purchasing decisions comprising:
receiving from a user information relating to at least one of a target audience of an advertiser or advertisement delivery preferences of the advertiser;
defining a selection of one or more proposed media advertising placements based on the information received from the user;
calculating projected future proposed impressions that will result from the selection of one or more proposed media advertising placements;
obtaining a measurement of current impressions that result from at least some of the media advertising placements;
maintaining at least some measured historical impressions that result from at least some media advertising placements ordered by the advertiser; and
providing to the user an interface comprising a representation of a number of impressions as a function of time, including at least some of the historical impressions over a first period of time, at least some of the current impressions, and at least some of the projected future proposed impressions over a second period of time.

2. The method of claim 1, wherein providing to the user an interface comprising a representation of a number of impressions as a function of time comprises providing to the user an interface comprising a chart of a number of impressions as a function of time.

3. The method of claim 1, wherein obtaining a measurement of current impressions that result from at least some of the media advertising placements comprises obtaining a measurement of current impressions that result from at least some of the media advertising placements ordered by the advertiser.

4. The method of claim 1, further comprising:
obtaining information about one or more media advertising placements secured by the advertiser;
calculating projected future secured impressions that will result from the one or more secured media advertising placements; and
displaying on the chart at least a portion of the projected future secured impressions.

5. The method of claim 1, further comprising:
receiving from the user one or more purchasing preferences of the advertiser;
receiving a purchasing instruction from the user to purchase at least a portion of the selection of one or more proposed media advertising placements; and
fulfilling the purchase by using at least some of the purchasing preferences.

6. The method of claim 5, further comprising:
storing at least some of the purchasing preferences in an advertiser data repository;
displaying in the interface an element that, when operated, creates the purchasing instruction; and
fulfilling the purchase immediately after the user operates the element by accessing the stored purchasing preferences from the advertiser data repository and using the stored purchasing preferences to purchase for the advertiser at least a portion of the selection of one or more proposed media advertising placements.

7. The method of claim 1, further comprising:
recording properties of media advertising placements associated with at least some of the measured historical impressions in a historical advertising order repository;
receiving from the user a request to create a selected time interval within the portion of the chart corresponding to the first period of time;
displaying on the chart one or more elements to delineate the selected time interval; and
displaying in the interface at least some of the properties of the media advertising placements associated with the historical impressions that occurred within the selected time interval.

8. The method of claim 1, further comprising:
receiving from the user a request to create a selected time interval within the portion of the chart corresponding to the second period of time; and
displaying on the chart one or more elements to delineate the selected time interval.

9. The method of claim 8, further comprising:
determining a number of the projected future proposed impressions that occur during the selected time interval; and
displaying the number in the interface.

10. The method of claim 8, further comprising displaying in the interface pricing information associated with the projected future proposed impressions within the selected time interval, wherein the pricing information comprises at least one of information about bids associated with the projected future proposed impressions or information about a purchase price associated with the projected future proposed impressions.

11. The method of claim 8, further comprising:
receiving a purchasing instruction from the user to make a purchase of the projected future proposed impressions within the selected time interval; and
fulfilling the purchase.

12. The method of claim 1, further comprising:
determining a total inventory of impressions available for future orders; and
displaying on the chart the total inventory of impressions available for future orders.

13. A system for providing advertising metrics in order to assist in media advertising purchasing decisions comprising a computer-readable memory device comprising instructions for:
receiving from a user information relating to at least one of a target audience of an advertiser or advertisement delivery preferences of the advertiser;
defining a selection of one or more proposed media advertising placements based on the information received from the user;
calculating projected future proposed impressions that will result from the selection of one or more proposed media advertising placements;
obtaining a measurement of current impressions that result from at least some media advertising placements ordered by the advertiser;
maintaining at least some measured historical impressions that result from at least some media advertising placements ordered by the advertiser; and
providing to the user an interface comprising a representation of a number of impressions as a function of time, including at least some of the historical impressions over a first period of time, at least some of the current impressions, and at least some of the projected future proposed impressions over a second period of time.

14. The system of claim 13, wherein the interface further comprises a second chart having a time axis, having an axis that represents a number of impressions, and showing at least some of the historical impressions over a third period of time longer than the first period of time.

15. The system of claim 14, wherein one or more default lengths of the first and second periods of time are not longer than about seven days, and wherein the third period of time is not shorter than about six months.

16. The system of claim 13, wherein the interface further comprises a time axis domain modification element that changes a duration and/or a starting time of the first and/or second periods of time without changing the magnitude of a sum of the first and second periods of time.

17. The system of claim 13, wherein the interface further comprises a time axis scale modification element that changes the magnitude of a sum of the first and second periods of time.

18. The system of claim 13, wherein the chart representing a number of impressions as a function of time comprises a chart representing a number of impressions as a function of at least about a fifteen-minute interval of time.

19. The system of claim 13, wherein the computer-readable memory device further comprises instructions for:
obtaining a reading of a secured portion of a total inventory of impressions that is at least one of already secured by the advertiser or unavailable to the advertiser; and
displaying on the chart at least a portion of the secured portion of the total inventory of impressions.

20. The system of claim 13, wherein the first chart further comprises at least one of a first line or a first area representing a portion of total inventory that is already secured by the advertiser and at least one of a second line or a second area representing a portion of total inventory that is otherwise unavailable to the advertiser, and wherein the at least one of a first line or a first area is a different color than the at least one of a second line or a second area.

21. The system of claim 13, wherein the interface further comprises an element that allows the user to at least one of immediately bid on or immediately purchase at least a portion of the selection of one or more proposed media advertising placements by operating the element.

22. A system for providing information to assist in a media advertising purchasing decision comprising:
a processor that projects a magnitude of future impressions as a function of time;
a data module that obtains measurements of current impressions;
a storage medium that maintains at least some measured historical impressions; and
an interface that provides user prompts in order to obtain purchasing preferences from a user, provides one or more interface elements that allow the user to provide criteria to filter an inventory of advertising impressions, and provides a representation of at least some of the historical impressions over a first period of time, at least some of the current impressions, and at least some of the projected future impressions over a second period of time.

23. The system of claim 22, wherein the data module comprises program code for obtaining measurements of current impressions from an impressions data source.

24. The system of claim 22, wherein the storage medium further maintains an inventory of available media advertising placements.

25. The system of claim 22, wherein the storage medium further maintains at least one of customer purchasing preferences or customer billing information.

26. The system of claim 22, wherein the storage medium comprises one or more hard disk drives.

27. The system of claim 22, further comprising a query module that selects one or more proposed media advertising placements based on information received from the user.

28. The system of claim 22, further comprising a communications network over which the interface receives instructions from the user and provides information to the user.

29. The system of claim 22, further comprising a communications network over which the data module communicates with a source of advertising metrics measurements.

30. A system for displaying metrics to a user in order to assist in a purchasing decision comprising:
means for receiving from the user a criterion to filter an inventory of a product;
means for defining a selection of one or more proposed orders for the product based on the criterion;
means for calculating a projected future metric that will result from the selection of one or more proposed orders;
means for obtaining a measurement of a current metric that results from at least some orders placed by the user;
means for retaining a measured metric that resulted from at least some orders placed by the user; and
means for displaying to the user at least a portion of the measured metric over a first period of time, at least a portion of the current metric, and at least a portion of the projected future metric over a second period of time.
